(19) United States
(12) Patent Application Publication
(10) Pub. No.: US 2011/0050876 A1
(43) Pub. Date: Mar. 3, 2011

(54) METHOD AND APPARATUS FOR DETECTING BEHAVIOR IN A MONITORING SYSTEM

(76) Inventors: Kazumi NAGATA, Fuchu-shi (JP); Kenji BABA, Kodaira-shi (JP); Takaaki ENOHARA, Hino-shi (JP); Akira SAWADA, Kiyose-shi (JP); Ichiro TOYOSHIMA, Tokyo (JP); Toyokazu ITAKURA, Kawasaki-shi (JP); Nobutaka NISHIMURA, Koganei-shi (JP); Ryoichi KURATA, Tokyo (JP)

(21) Appl. No.: 12/859,043

(22) Filed: Aug. 18, 2010

(30) Foreign Application Priority Data
Aug. 26, 2009 (JP) 2009-195365

(51) Int. Cl. H04N 7/18; G06K 9/68

(52) U.S. Cl. 348/77; 382/218; 348/E07.085

(57) ABSTRACT

According to one embodiment, a behavior detection apparatus includes an image acquisition unit, a characteristic acquisition unit, a behavior identification unit, and a detection unit. The image acquisition unit is configured to acquire the image data about an object to detect. The characteristic acquisition unit is configured to acquire characteristic data about the object, from the image data. The behavior identification unit is configured to identify the behavior of the object on the basis of the characteristic data. The detection unit is configured to compare the behavior identified by the behavior identification unit with the scheduled behavioral data representing the behavior the object is supposed to exhibit, thereby to detect abnormal behavior by the object.

### CROSS-REFERENCE TO RELATED APPLICATIONS

This application is based upon and claims the benefit of priority from Japanese Patent Application No. 2009-195365, filed Aug. 26, 2009; the entire contents of which are incorporated herein by reference.

### FIELD

Embodiments described herein relate generally to the technique of detecting abnormal behavior of people by processing image data about the people.

### BACKGROUND

In recent years, data centers (including computer centers) have started providing an information-related service called a collocation service. The collocation service leases server rooms, the operation of which is managed by data centers, to companies, i.e., the users of the data centers. In most cases, a plurality of servers is installed in each server room.

To receive the collocation service, any user of a data center possesses a server installed in the server room and may carry out maintenance on the server. In this case, the user sends maintenance personnel to the server room. In the server room, the personnel carry out maintenance on the server and apparatuses peripheral thereto (e.g., disk drives and the like).

Because servers belonging to other users are installed in the server room, the server room requires high-level security. Therefore, every entry to, and every exit from, the server room is strictly checked by utilizing biometric authentication, smartcards or the like, in most cases. However, no measures are taken to achieve strict management of the behavior of any person, such as an operator, who has entered the server room in order to prevent information leakage through, for example, unauthorized physical access to the servers.

Systems have hitherto been proposed, which compare the reservations registered for a server with the maintenance log for the server, thereby to detect later the unauthorized activity carried out in connection with the server. These systems that detect unauthorized activity later indeed achieve a so-called “information security function.” However, in order to eliminate information leakage due to unauthorized physical access to the server installed in the server room, a so-called “physical security function” must be performed to detect abnormal behavior the maintenance personnel may exhibit in the server room.

### BRIEF DESCRIPTION OF THE DRAWINGS

FIG. 1 is a block diagram explaining the configuration of a monitoring system according to an embodiment;

FIG. 2 is a block diagram explaining the configuration of the image processing unit according to the embodiment;

FIG. 3 is a flowchart explaining the operation of the image processing unit according to the embodiment;

FIG. 4 is a flowchart explaining the operation of the monitoring system according to the embodiment;

FIG. 5 is a timing chart explaining the operation of the monitoring system according to the embodiment; and

FIG. 6 is another timing chart explaining the operation of the monitoring system according to the embodiment.

### DETAILED DESCRIPTION

In general, according to one embodiment, a behavior detection apparatus includes an image acquisition unit, a characteristic acquisition unit, a behavior identification unit, and a detection unit.

The image acquisition unit is configured to acquire the image data about an object to detect. The characteristic acquisition unit is configured to acquire characteristic data about the object, from the image data. The behavior identification unit is configured to identify the behavior of the object on the basis of the characteristic data. The detection unit is configured to compare the behavior identified by the behavior identification unit with the scheduled behavioral data representing the behavior the object is supposed to exhibit, thereby to detect abnormal behavior by the object.

With reference to the accompanying drawings, the monitoring system according to the embodiment will be described.

### [Configuration of the System]

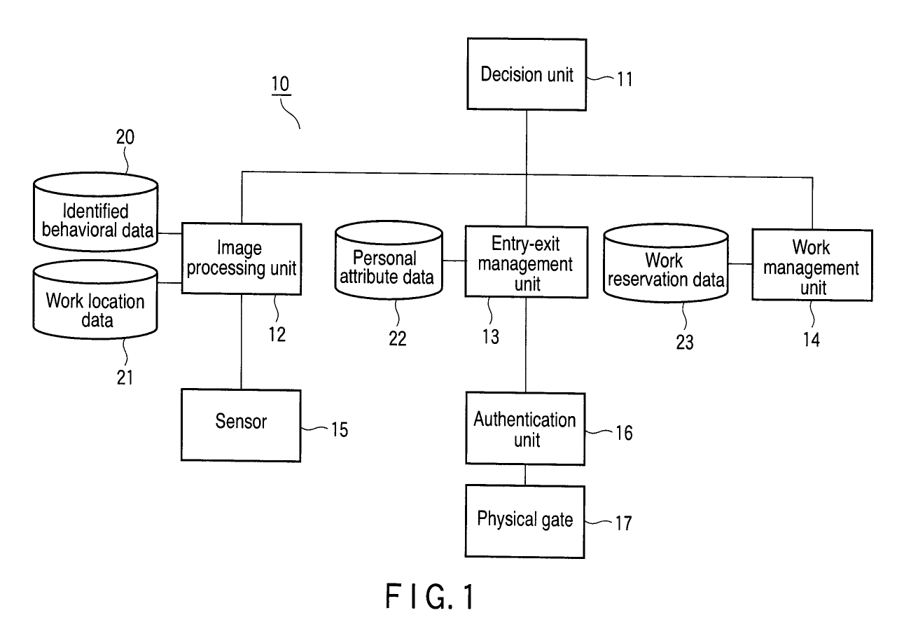

FIG. 1 is a block diagram explaining the configuration of a monitoring system 10 according to the embodiment.

The monitoring system 10 is composed, mainly of a decision unit 11, an image processing unit 12, an entry-exit management unit 13, and a work management unit 14. The monitoring system 10 is constituted by the hardware and software of a computer system.

The functional units 12 to 14 are computers. They are connected to one another by a network, and may exchange data with one another. The network includes not only a computer network such as a LAN, but also a communication network to which mobile telephones, for example, are connected.

The decision unit 11 determines whether any person entered or exited the server room is an authenticated one and whether the behavior of any person in the server room is appropriate. That is, the decision unit 11 is a unit that detects normal behavior if the person engages in inappropriate activity in the server room. In the present embodiment, the server room is regarded as a region the system monitors.

The image processing unit 12 has a function of processing image data input from a sensor 15 such as a camera and a function of identifying the behavior of a person monitored. The image processing unit 12 refers to a database 20 storing the data about the identified behavior, and also to a database 21 storing work location data.

The entry-exit management unit 13 manages the persons who have entered and exited the server room, on the basis of the authentication data acquired at an authentication unit 16 that reads data from, for example, smartcards. The entry-exit management unit 13 acquires personal attribute data from the authentication unit 16 and accumulates the personal attribute data in a database 22. The entry-exit management unit 13 also controls the opening and closing of the physical gate 17, such as automatic door, provided at the entrance to the server room.

The work management unit 14 manages the work reservation data accumulated in a database 23. More precisely, the work management unit 14 receives the work reservation data input by the operator stationed at the data center that manages the server room, registers the work reservation data in the database 23 and provides the work reservation data registered in the database 23, on receiving a request coming from the decision unit 11.

The work reservation data represents the work the operator has applied beforehand to the manager of the data center so that he or she may perform it in the server room. More specifically, the work reservation data contains the type of work, the date and time of work, the work place, the work sequence, the work area, the rack position, the server position data, etc.

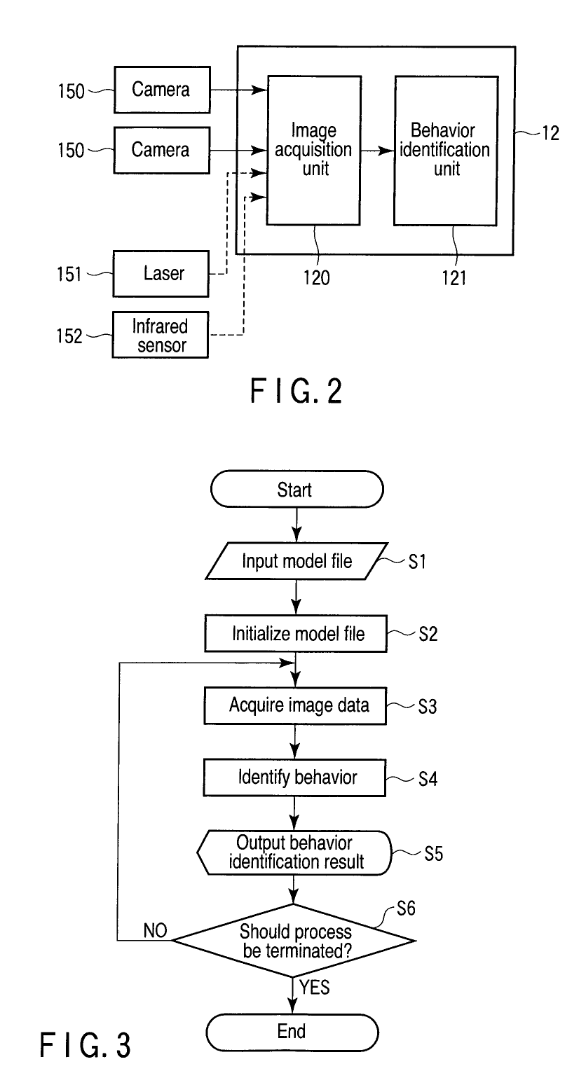

As shown in FIG. 2, the image processing unit 12 includes an image acquisition unit 120 and a behavior identification unit 121. The image acquisition unit 120 acquires image data input from the sensor 15 and stores the image data in an internal buffer memory. The sensor 15 is composed of cameras 150 or is a laser detector 151 or an infrared sensor 152. In this embodiment, the image acquisition unit 120 acquires image data (video data) generated by the cameras 150 installed in the server room, which have photographed persons working in the server room.

### [Operation of the System]

How the system according to this embodiment operates will be explained, with reference to FIGS. 3 to 6.

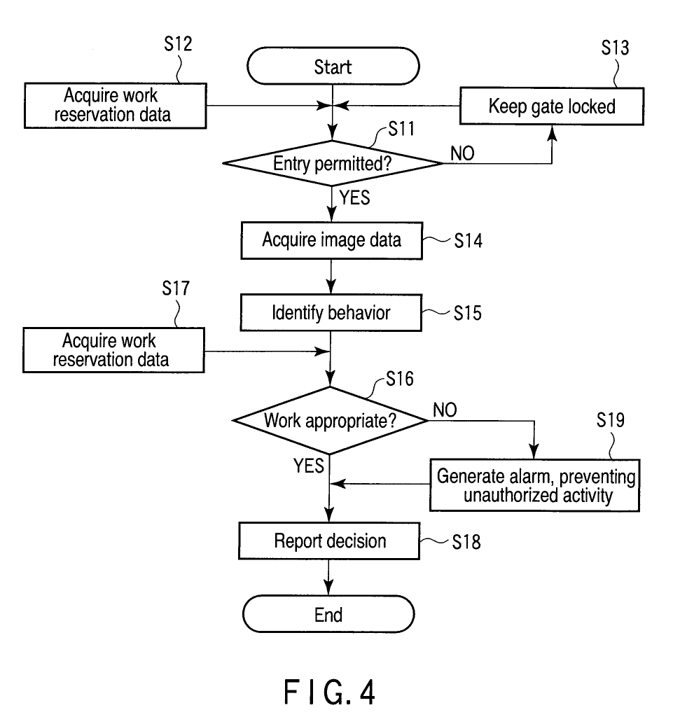

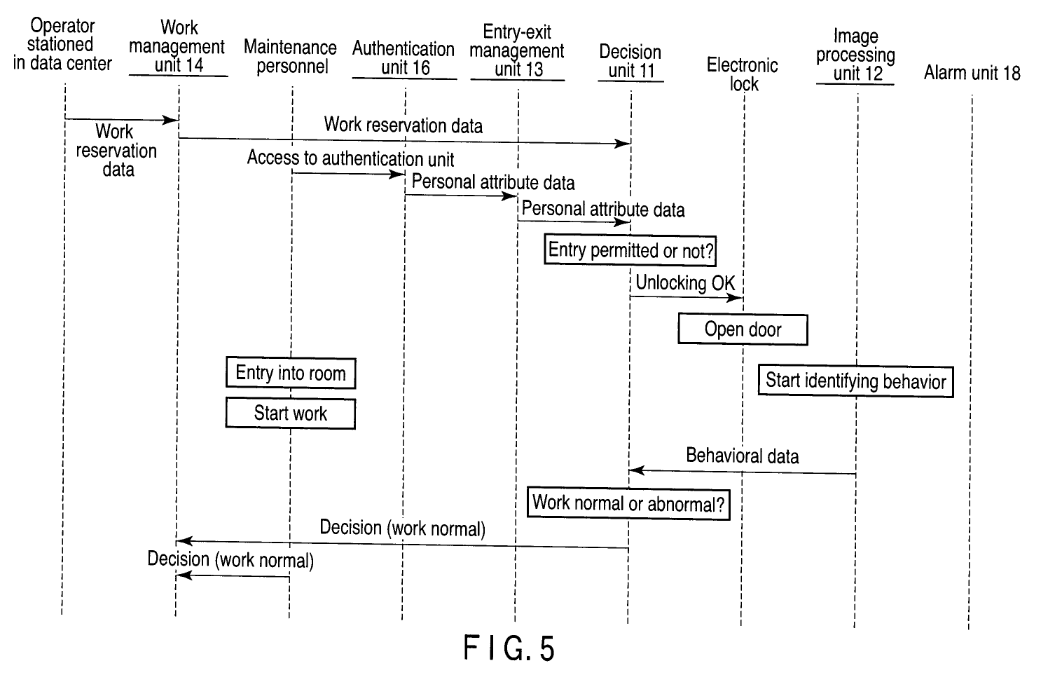

First, how the entry-exit management unit 13 of the system 10 operates when an operator tries to enter the server room will be explained, with reference to the flowchart of FIG. 4 and the flowchart of FIG. 5. The “operator” is a person sent from a user of the data center that manages the server room.

In order to access to the server room, the operator places his or her smartcard in contact with the authentication unit 16 provided at the entrance to the server room. The authentication unit 16 reads the personal attribute data from the smartcard and authenticates the holder of the smartcard. The entry-exit management unit 13 acquires the personal attribute data from the authentication unit 16 that has authenticated the operator, and then stores the personal attribute data in the database 22.

The decision unit 11 compares the personal attribute data acquired by the entry-exit management unit 13 with the work reservation data registered beforehand, determining whether the operator who will perform the reserved work is identical to the operator who intends to enter the server room (Step S11). Then, as shown in FIG. 5, the decision unit 11 obtains, from the work management unit 14, the work reservation data containing the operator name, work date, reserved work time, etc., all registered in the database 23 (Step S12).

The operator who should perform the reserved work may be identical to the operator who intends to enter the server room, and the reserved work time may be almost identical to the time the operator places his or her smartcard in contact with the authentication unit 16 (YES in Step S11). If this case, the system 10 unlocks, for example, the electronic lock on the physical gate 17 that is, for example, an automatic door of the server room. The operator can therefore enter the server room.

If the operator who should perform the reserved work is not identical to the operator who intends to enter the server room (NO in Step S11), the physical gate 17 remains locked (Step S13). In this case, the operator at the authentication unit 16 cannot enter the server room.

Next, how the system 10 operates after the operator has entered the server room will be explained. How the operation of the image processing unit 12 will be described in the main, with reference to the flowchart of FIG. 3.

In this embodiment, cameras 150 are installed in the server room. The cameras 150 photograph any persons who have entered the server room. In the image processing unit 12, the image acquisition unit 120 receives an image signal (video signal) transmitted from the camera 150 and converts the signal to image data (video data) (Step S3).

If the image processing unit 12 is the single-lens image processing type, it receives the image data generated by one camera 150. If the image processing unit 12 is the stereoscopic image processing type, it acquires stereoscopic image data from two video signals transmitted from two cameras 150. In this embodiment, no limitation is set to the number of cameras 150 used or to the view angle.

The image processing unit 12 first receives a model file for use in processing image data (Step S1). The image processing unit 12 then initializes the model file (Step S2). The image processing unit 12 processes the image data acquired, identifying the behavior of the person (i.e., operator) who has entered the server room. (The behavior is mainly access to the server.) Further, the image processing unit 12 determines the position of the server the operator is accessing. The image processing unit 12 then generates the operator's behavior ID data (containing the server position data and the like). How the operator's behavior ID data is generated will be explained below, in detail.

In the image processing unit 12, the behavior identification unit 121 performs behavior identification on the basis of the image data acquired (Step S4). The behavior identification unit 121 also performs a process of identifying the work (access) position. The behavior identification unit 121 outputs the result of the behavior identification (i.e., behavior identification file) and the work (access) position data (i.e., position data file) to the decision unit 11, and displays these data items on the display screen of the system 10 (i.e., computer system) (Step S5).

The behavior identified in the server room is the opening of the rack of the server main unit, the exchange of hard disk drives (HDDs), the insertion and removal of flash drives, the manipulation of the keyboard or mouse, the cabling, or the like. That is, it is the operator's activity related to so-called “physical access” to an apparatus such as the server or the rack thereof. The work (access) position identified is, for example, the position of the interface with external unit media.

The behavior identification unit 121 identifies behavior of another type, equivalent to unauthorized activity such as the removal or destruction of disk drives. Further, the behavior identification unit 121 identifies the operator's position (for example, standing position, stooping position, or crouching position) and the operator's physical access to the server (regardless of the height of the server). To identify the work (access) position, the behavior identification unit 121 determines where in the server room the operator exists, at which rack the operator stands, or which server the operator is accessing.

The behavior identification unit 121 may perform the behavior identification process in a rule-based method. If so, the unit 121 can identify the behavior on the basis of a threshold value set for specific data. To identify, for example, a flash-drive insertion the operator performs in a crouching position, the crouching position the operator assumes is determined from the characteristic data representing the height of the operator's image. Alternatively, the crouching position is determined from the representing the operator's silhouette, thereby identifying the flash-drive insertion. In this case, the threshold value, i.e., identification reference, is changed.

Thus, after the operator has entered the server room, the image processing unit 12 of the system 10 acquires the image data about the operator from the camera 150 (Step S14) as shown in the flowchart of FIG. 4. In the image processing unit 12, the behavior identification unit 121 performs the behavior identification process, identifying the behavior of the operator and the work (access) position (Step S15).

Next, the decision unit 11 of the system 10 determines whether the operator's work (behavior or activity) in the server room is appropriate or not, from the behavior identification result output from the image processing unit 12 (Step S16). To be more specific, the decision unit 11 refers to the work reservation data registered in the database 23, and compares the work reservation data with the behavioral data, i.e., the behavior identification result (Step S17). It should be noted here that the work reservation data is associated with the personal attribute data managed by the entry-exit management unit 13.

As shown in FIG. 5, the decision unit 11 obtains the work reservation data registered in the database 23, from the work management unit 14. The work management unit 14 registers, in the database 23, the work reservation data input by the operator stationed in the data center that manages the server room. The work reservation data represents the type of the work that the operator assigned to work in the server room has applied beforehand to the manager of the data center, so that he or she may perform it in the server room. More specifically, the work reservation data contains the type of work, the date and time of work, the work place, the work sequence, the work area, the rack position, the server position data, etc.

If the decision unit 11 determines that the operator's work (behavior or activity) in the server room is appropriate (YES in Step S16), the system 10 outputs the decision made by the decision unit 11 to a terminal. The display of the terminal displays the decision on its screen, informing the operator stationed in the data center or the manager of the server (Step S18).

The decision unit 11 may not determine that the operator's work (behavior or activity) in the server room is appropriate (NO in Step S16). In other words, the decision unit 11 may detect that the operator is engaging in abnormal behavior in the server room. In this case, the decision unit 11 compares the work reservation data (i.e., data associated with time axis) with the behavioral data (i.e., behavior identification result), detecting the abnormal behavior. That is, if the work reservation data contains the work that should be performed on specific day and at specific time, the decision unit 11 compares the data with the behavioral data acquired on the same day and at the same time. More precisely, the work reservation data may represent a specific day and a specific time on the day, at which the disk drive of the server should be exchanged with another. Then, the operator's behavior will be detected as abnormal if the date and time of the behavior differ from the work reservation data.

If the decision unit 11 determines that the behavior is abnormal, the system 10 locks the electronic lock at the entrance to the server room, closing the physical gate 17 (Step S19). This disables the operator from exiting the server room if he or she is found be engaging in unauthorized activity (abnormal behavior) in the server room.

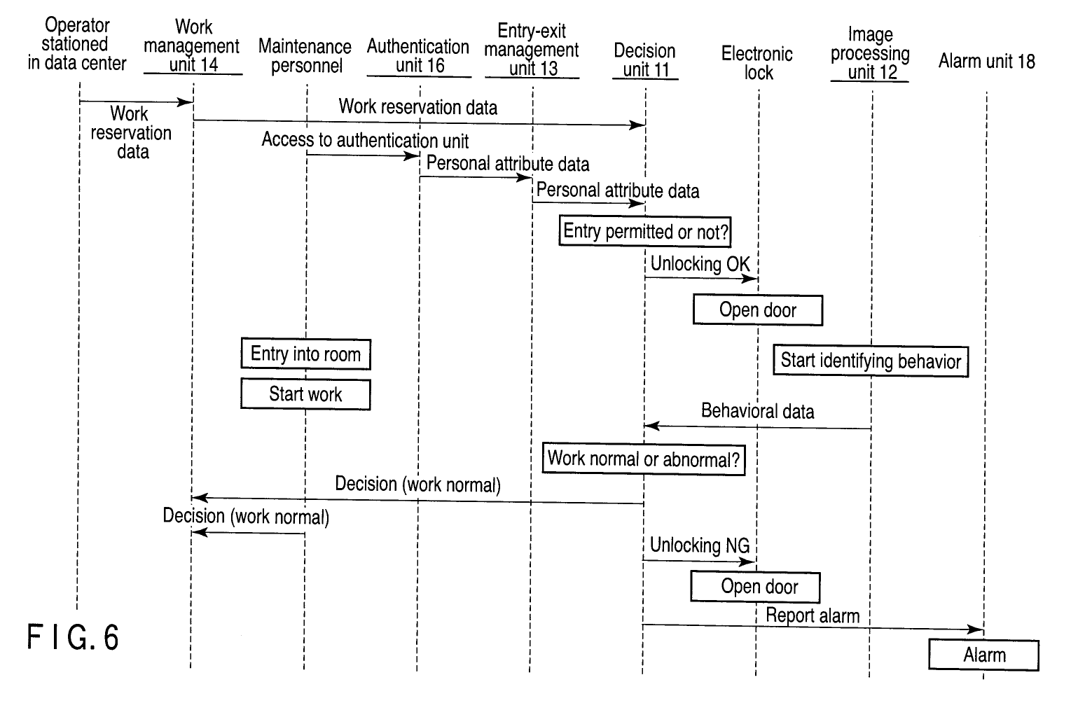

The system 10 controls an alarm unit 18 to generate an alarm, which is sent to the operator stationed in the data center. Alternatively, the system 10 may cause the speaker provided in the server room to generate a warning. When the operator's abnormal behavior is detected in the server room, the system 10 not only takes security measures against unauthorized activity, such as locking of the entrance to the server room, but also informs the operator stationed in the data center or the manager of the server of the abnormal behavior, as is illustrated in the timing chart of FIG. 6 (Step S18).

Configured as described above, the system 10 according to the embodiment can monitor any operator who has entered the server room, for any possible abnormal behavior (activity) in the server room. That is, whether the operator's behavior is appropriate or not is determined on the basis of the work reservation data registered, and the prescribed measures are taken if the operator is found making an inappropriate behavior in the server room (if normal behavior is detected). The measures taken are, for example, locking the door to the server room, sending an alarm to the manager at the data center, and generating a warning in the server room.

These measures taken make the operator in the server room interrupt an unscheduled work such as taking a disk drive from the server room. Even if any suspicious person disguising an operator has entered the server room, he or she cannot engage in unauthorized activity such as accessing of the server, removing disk drives. Therefore, not only can any unauthorized access to the server be detected later from the work log, but also any physical access to the server or any other abnormal behavior in the server room can be detected immediately and interrupted. This eliminates the risk of information leakage due to unauthorized physical access to the server.

In the system 10, the decision unit 11 reports the behavior identification result to the work management unit 14. Having received the report, the work management unit 14 can manage the personal attribute data about any suspicious person lingering in the server room and the log of physical access the person has made to the server.

Moreover, in the system 10, the image photographed of a suspicious person (operator) engaging in abnormal behavior in the server room may be registered in a database. Then, the operator stationed in the data center can refer to the image to determine that unauthorized activity is taking place in the server room.

As has been described, the system according to this embodiment can achieve a physical security function of detecting abnormal behavior of a person in the server room and of ultimately preventing unauthorized activity such as unauthenticated physical access to the server.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A behavior detection apparatus comprising:
an image acquisition unit configured to acquire image data about an object to detect;
a characteristic acquisition unit configured to acquire characteristic data about the object, on the basis of the image data;
a behavior identification unit configured to identify a behavior of the object, on the basis of the characteristic data; and
a detection unit configured to detect abnormal behavior of the object, on the basis of a result of comparison between the identified behavior and scheduled behavioral data representing a scheduled behavior.

2. The apparatus of claim 1, further comprising a storage unit configured to store work reservation data representing the work that the object is supposed to perform,
wherein the detection unit is configured to refer to the reserved work data acquired from the storage unit and used as the scheduled behavioral data, and to detect abnormal behavior if the behavior of the object is found not to be a scheduled work on the basis of a result of the comparison between the identified behavior and the scheduled behavioral data.

3. The apparatus of claim 2, wherein the work reservation data contains data associated with time axis and representing the scheduled work, and the detection unit is configured to compare the work reservation data with the identified behavior on the time axis, thereby detecting abnormal behavior if the work reservation data and the identified behavior differ from each other.

4. The apparatus of claim 1, further comprising an authentication unit configured to authenticate a person existing in a monitored region,
wherein the detection unit detects abnormal behavior of the person set as the object and existing in the monitored region, and the behavior identification unit acquires image data about the person authenticated by the authentication unit and therefore allowed to enter the monitored region.

5. The apparatus of claim 4, further comprising a storage unit configured to store work reservation data representing the work that the object is supposed to perform,
wherein the detection unit uses personal attribute data generated as the authentication unit authenticates the person, and refers to the work reservation data about the person and stored in the storage unit, and detects normal behavior of the person.

6. The apparatus of claim 1, wherein the behavior identification unit is configured to output, as identified behavior, the activity a person engages in and the position where the activity is engaged in.

7. A monitoring system comprising:
a behavior detection apparatus as described in claim 1; and
a camera configured to photograph any object exiting in a preset monitoring region and to transmit image data representing an image of the object to the behavior identification unit included in the behavior detection apparatus.

8. The system of claim 7, further comprising a safeguard unit configured to interrupt or prevent unauthorized activity by a person existing in the monitored region if the detection unit included in the apparatus detects abnormal behavior of the person set as the object.

9. The system of claim 8, wherein the safeguard unit is configured to prevent the person from exiting the monitored region.

10. The system of claim 8, wherein the safeguard unit is configured to generate a warning to the person existing in the monitored region.

11. The system of claim 7, wherein the monitored region is a server room in which a server is installed.

12. A method of detecting a behavior, comprising:
acquiring image data about an object;
acquiring characteristic data about the object on the basis of the image data;
identifying a behavior of the object, on the basis of the characteristic data; and
detecting abnormal behavior of the object, on the basis of a result of comparison between the identified behavior and scheduled behavioral data representing a scheduled behavior.

13. A non-transitory computer readable medium having stored thereon a computer program which is executable by a computer and which causes the computer to execute functions of:
acquiring image data about an object;
acquiring characteristic data about the object on the basis of the image data;
identifying a behavior of the object, on the basis of the characteristic data; and
detecting abnormal behavior of the object, on the basis of a result of comparison between the identified behavior and scheduled behavioral data representing a scheduled behavior.
